(19) United States
(12) Patent Application Publication
(10) Pub. No.: US 2005/0270764 A1
(43) Pub. Date: Dec. 8, 2005

(54) Method and apparatus to illuminate the interior of a fashion accessory

(75) Inventors: Kara C. Kurcz, Los Angeles, CA (US); Brian M. Lee, Los Angeles, CA (US)

Correspondence Address: DAVIS WRIGHT TREMAINE LLP, 865 FIGUEROA STREET, SUITE 2400, LOS ANGELES, CA, 90017-2566, US

(73) Assignee: Big Bang Industries, LLC, Los Angeles, CA (US)

(21) Appl. No.: 11/200,470

(22) Filed: Aug. 9, 2005

Related U.S. Application Data
(63) Continuation-in-part of application No. 10/972,008, filed on Oct. 22, 2004.
Application No. 10/972,008 is a continuation-in-part of application No. 10/447,784, filed on May 29, 2003, now abandoned.
(60) Provisional application No. 60/385,683, filed on Jun. 4, 2002.

(51) Int. Cl. F21K 2/00

(52) U.S. Cl. 362/34

(57) ABSTRACT

The invention includes an apparatus for illuminating the interior of a fashion accessory and a method for assembling the same. Various elements of the illumination device may be obscured from view by including the same behind an interior lining of the fashion accessory, and the illumination source(s) may be selected so as to provide illumination of a desired color. Additionally, the power source may be rechargeable, and may be configured to power additional electronic devices. Still further, the illumination source and frame of the fashion accessory may be assembled separately from the remaining, non-rigid components thereof.

This application is a continuation-in-part of U.S. patent application Ser. No. 10/972,008, filed Oct. 22, 2004, which is a continuation-in-part of U.S. patent application Ser. No. 10/447,784, filed May 29, 2003, now abandoned, which claims the benefit of priority under 35 U.S.C. § 119 of provisional U.S. application Ser. No. 60/385,683, filed Jun. 4, 2002. The contents of the aforementioned applications are hereby incorporated by reference in their entirety as if fully set forth.

### FIELD OF THE INVENTION

The present invention relates to fashion accessories and, more particularly, to a method and apparatus for illuminating the interior of the same.

### BACKGROUND OF THE INVENTION

Individuals frequently employ any number of portable fashion accessories to transport their personal effects. For example, many women carry a purse or pocketbook, and, modem trends have seen a growth in the number of similar accessories for men beyond the traditional briefcases and attaches. A variety of items may be stored and contained within such accessories, yet, without proper illumination, locating particular items within these accessories can be both difficult and frustrating.

### SUMMARY OF THE INVENTION

Embodiments of the present invention provide an apparatus and method to illuminate the interior of a fashion accessory. The illumination device of the present invention may be at least partially concealed by an interior lining or another component of the fashion accessory, so as to reduce the visibility of the device; thereby providing an attractive final product.

In various embodiments, the illumination may be provided by an illumination source that is stitched or otherwise affixed to at least a portion of the perimeter of the interior of the fashion accessory. By way of example, it may be sewn into the interior lining of the fashion accessory and/or secured to the fashion accessory by the frame or another rigid component of the fashion accessory. In still further embodiments of the present invention, the illumination source may be mechanically affixed to the frame or to another rigid component of a fashion accessory to create an assembly that may thereafter be attached to one or more remaining elements of the accessory that, in various embodiments, may be constructed of relatively less rigid materials (e.g., cloth, fabric, leather, etc.).

The illumination may be provided in any number of colors, owing to a selection of one of a variety of illumination sources described in alternate embodiments of the present invention. The illumination source may also be a dual illumination source; for example, two strands of electroluminescent wire in electronic communication with a bifurcated wire that couples the strands of electroluminescent wire to a unitary power source. In an alternate embodiment, the illumination source may be one or more lights, such as light emitting diodes or “LEDs,” in optical communication with a light-transmitting material (e.g., various plastics, glass, etc.) configured in the frame or other rigid component of a fashion accessory. For instance, a groove may be formed through a frame of a fashion accessory that is filled with the light-transmitting material. In operation, when the one or more lights (e.g., LEDs) are illuminated, the light given off is transmitted through the light-transmitting material, such that a glowing effect along the entirety of the light-transmitting material is created.

Further embodiments of the present invention provide a device to illuminate the interior of a fashion accessory that switches into an “on” position when the accessory is opened and, conversely, switches into an “off” position when the accessory is closed.

Still further embodiments of the present invention provide a recharging assembly that may be used to recharge a rechargeable battery in electronic communication with the illumination source. The recharging assembly may be configured to receive external power from a cigarette lighter adapter, from a wall outlet, from a solar power source, or the like. The recharging assembly may additionally include an internal fashion accessory power outlet that may be used to power an electronic device, such as an MP3 player, a personal data assistant (“PDA”), a cellular telephone, or another electronic device.

### BRIEF DESCRIPTION OF THE FIGURES

FIG. 1 illustrates a perspective view of a fashion accessory including an illumination device in accordance with an embodiment of the present invention. The fashion accessory is shown in an open position.

FIG. 2 illustrates a perspective view of a fashion accessory including an illumination device in accordance with an embodiment of the present invention, wherein various elements of the illumination device are obscured from view by an interior lining of the fashion accessory. The fashion accessory is shown in an open position.

FIG. 3 illustrates an illumination device in accordance with an embodiment of the present invention, prior to installation in a fashion accessory.

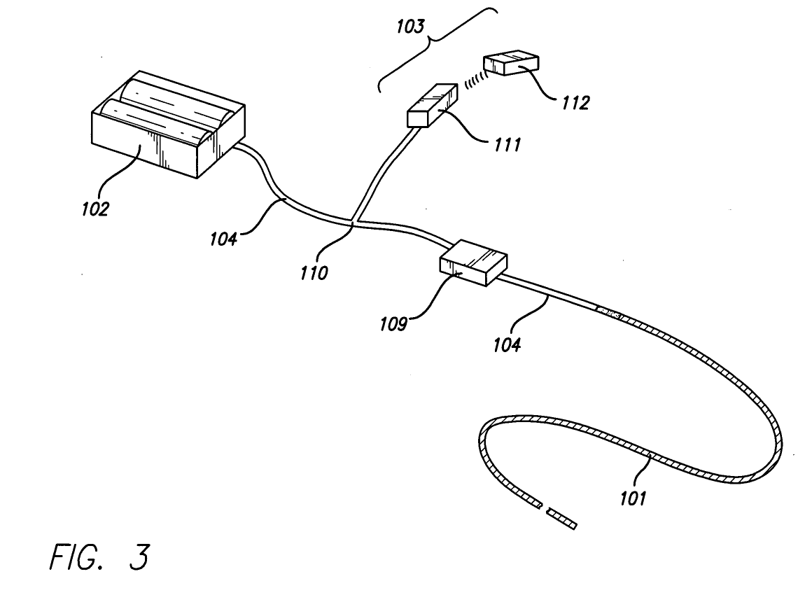

FIG. 4 illustrates a perspective view of a fashion accessory including an illumination device in accordance with an embodiment of the present invention. The fashion accessory is shown in a closed position.

FIG. 5 illustrates an illumination device with a dual illumination source in accordance with an embodiment of the present invention, prior to installation in a fashion accessory. The dual illumination source is in electronic communication with a bifurcated wire in further electronic communication with a unitary power source.

FIG. 6 illustrates a top view of a fashion accessory in accordance with an embodiment of the present invention. The fashion accessory includes a dual illumination source, and a battery pack in a battery pack holder that is stitched into an inside lining of the fashion accessory.

FIG. 7 illustrates an exploded view of the mounting of an electroluminescent wire to a fashion accessory in accordance with an embodiment of the present invention. A lip of the electroluminescent wire that runs along its axial length is secured (e.g., sewn) to the edge of the inside lining of the fashion accessory, around which the frame of the fashion accessory is subsequently fastened (e.g., by crimping).

FIG. 8 illustrates a recharging assembly in accordance with an embodiment of the present invention.

FIG. 9 illustrates alternate frames configured with a light-transmitting material and one or more lights, in accordance with an embodiment of the present invention. Various frames are illustratively depicted, including a sidewall frame with a switch and inverter assembly at one end (FIG. 9A), a sidewall frame with a switch and inverter assembly in the center (FIG. 9B), and a bottom frame with a switch and inverter assembly configured for being remotely affixed to fashion accessory and in electronic communication with the one or more lights via wiring (FIG. 9C). FIG. 9D illustrates a cross-sectional view of the frame attached to a seam or other portion of a fashion accessory.

FIG. 10 illustrates an electroluminescent wire mechanically affixed to a rigid component of a fashion accessory (FIG. 10A) and a cross-sectional view of the same attached to a seam or other portion of a fashion accessory (FIG. 10B), in accordance with an embodiment of the present invention.

FIG. 11 illustrates a unitary assembly that includes a magnetic reed switch and inverter in accordance with an embodiment of the present invention.

### DETAILED DESCRIPTION OF THE INVENTION

Embodiments of the present invention provide an illumination device for illuminating the interior of a fashion accessory. Such illumination may render it more convenient for one to locate a particular item contained inside that accessory, especially when ambient lighting conditions are such that one would otherwise have difficulty visually discerning among the contents of the accessory. By way of example, embodiments of the illumination device of the present invention may be useful when one is searching for a particular item in a handbag in a dimly lit room, or when trying to find car keys in a similar handbag, when in a parking lot at night.

The illumination device of the present invention has the additional benefit of imparting a new, fashionable quality to a fashion accessory, since in alternate embodiments the illumination source may be selected from a range of colors. Thus, when illuminated, the interior of the fashion accessory may be illuminated or may glow with the selected color. For example, in one embodiment of the present invention, the interior of a purse may be illuminated with light of a blue hue, when a corresponding illumination source is selected. However, as will be readily appreciated by those of skill in the art, any number of colors may be selected for the illumination source in connection with alternate embodiments of the present invention. Moreover, in an alternate embodiment, multiple illumination sources may be included in a fashion accessory. This may have a number of benefits, among which is the ability to create an illumination hue based on a combination of hues from individual illumination sources (e.g., an illumination source with a yellow hue in combination with an illumination source with a blue hue may create the effect of a green hue when used in combination).

Moreover, in alternate embodiments of the present invention, at least a portion of the illumination apparatus may be concealed from view within the lining or another similar part of the fashion accessory; thereby minimizing or eliminating an individual's ability to see the mechanism responsible for providing the illumination effect. This may be particularly advantageous insofar as embodiments of the present invention may be included in a fashion accessory, in which one would likely prefer to obfuscate various elements of the illumination device (e.g., wiring, power source) from view to the greatest extent practicable. Thus, in a preferred embodiment of the present invention, the illumination source and switch that controls the illumination source are visible upon opening the fashion accessory, while the remaining elements of the illumination device remain substantially hidden from view.

Fashion accessories suitable for use in accordance with embodiments of the present invention include, but are in no way limited to, purses, handbags, pocketbooks, wallets, backpacks, briefcases, satchels, luggage, suitcases, cases for sunglasses or makeup, and any other suitable fashion accessory as will be readily recognized by one in the art.

Illumination sources suitable for use in accordance with embodiments of the present invention include, but are in no way limited to, tubular illumination mechanisms such as electric luminescent wire, fiber optic illumination sources, light bulbs, LEDs, and any other component that may be configured to provide illumination to the interior of a fashion accessory as will be readily appreciated by those of skill in the art. In one embodiment of the present invention, the illumination source is electric luminescent wire, available, for example, under the tradename LYTEC® from Elam Electroluminescent Industries, Ltd. (Jerusalem, Israel).

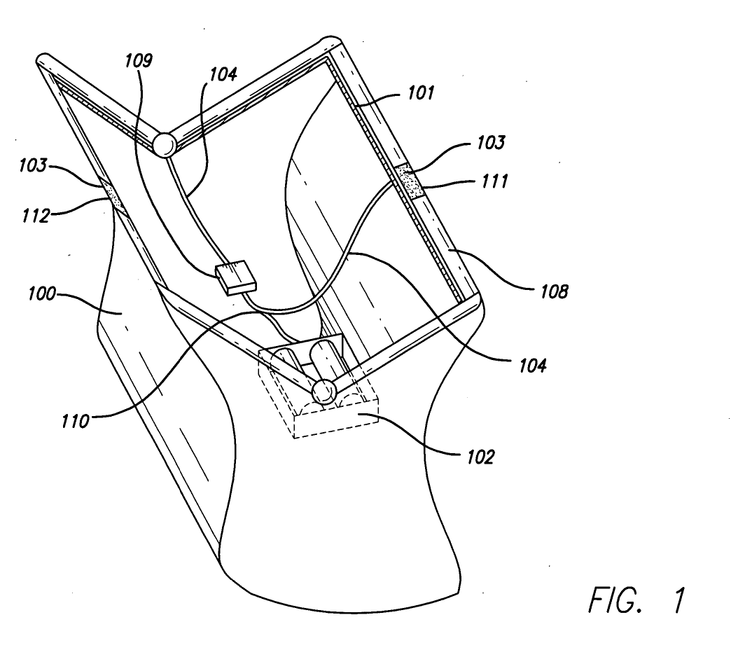

With reference to FIG. 1, in one embodiment of the present invention, a fashion accessory 100 includes an illumination source 101 that is electrically coupled to a power source 102. Power sources 102 suitable for use in accordance with embodiments of the present invention include, but are in no way limited to, batteries, solar cells, and the like. In a preferred embodiment of the present invention, the power source 102 includes a battery, and, in a most preferred embodiment, the power source 102 includes two AA batteries. It will be readily apparent to one in the art that the power source 102 of the present invention may be selected as appropriate to provide sufficient power, as per the electrical requirements of the illumination source 101.

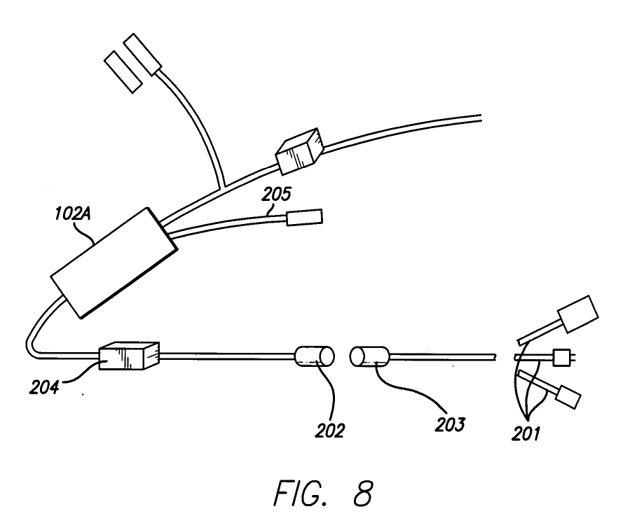

In an alternate embodiment of the present invention, as depicted in FIG. 8, the power source 102 may be a rechargeable power source 102A, which may be configured to receive external power (e.g., to recharge) from an external power source 201, such as a cigarette lighter adapter, a wall outlet, a solar power source, or any other suitable source of external power.

Electronic communication may be established between the rechargeable power source 102A and the external power source 201 by a pair of adaptor jacks 202, 203. The first adaptor jack 202 may be configured on the fashion accessory in a convenient location, such as a location on the accessory that is externally accessible or it may be configured on the interior of the fashion accessory to aid in hiding it from external view. A power converter 204 may be included between the rechargeable power source 102A and the pair of adaptor jacks 202, 203. The second adaptor jack 203 may be configured on a separate assembly that includes means for electronic communication between the second adaptor jack 203 and the external power source 201.

Furthermore, the recharging assembly may include an internal fashion accessory power outlet 205 that may be used to power an electronic device, such as an MP3 player, a personal data assistant (“PDA”), a cellular telephone, or another electronic device. The internal fashion accessory power outlet 205 may be configured on the interior of the fashion accessory, and may include a means for providing electronic communication between the internal fashion accessory power outlet 205 and the electronic device powered by the rechargeable power source 102A.

The illumination source 101 may be further electrically coupled to a switch 103, that controls the illumination source 101 such that the illumination source is in an “on” position when the fashion accessory 100 is open, and an “off” position when the fashion accessory 100 is closed. The switch 103 of the present invention may be any suitable switch 103 that operates to control the “on” and “off” state of the illumination source 101, but in preferred embodiments the switch 103 is a magnetic reed switch. A magnetic reed switch used in embodiments of the present invention may include two elements, as illustratively depicted in FIG. 1. A first element 111 may be electrically coupled to the power source 102, and a second element 112 may be in magnetic contact with the first element 111. In preferred embodiments of the present invention, the first element 111 and the second element 112 are affixed or otherwise attached to the opening 108 of a fashion accessory 100, such that the elements 111, 112 are in magnetic contact with one another when the fashion accessory 100 is closed, and are separated from one another when the fashion accessory 100 is opened. In such embodiments, when the fashion accessory 100 is opened, the two elements 111, 112 preferably separate to a distance far enough away from one another such that the switch 103 functions to operate the illumination source 101.

The illumination source 101, power source 102, and switch 103 may be electrically coupled by any suitable mechanism such as wires 104, although other mechanisms for providing such electric coupling will be readily apparent to one in the art. In one embodiment of the present invention, the wires 104 include a junction 110 where the wires 104 split to reach the switch 103 at one end of the junction 110 and the illumination source 101 at the other end of the junction 110.

As further depicted in FIG. 1, in an alternate embodiment of the present invention, an inverter 109 may be included between the power source 102 and the illumination source 101. The inverter 109 may adjust the power level so as to provide an appropriate amount of power to the illumination source 101. An inverter 109 is illustratively depicted in FIG. 1 between the power source 102 and the junction 110, although in alternate embodiments of the present invention, an inverter 109 may be included between the junction 110 and the illumination source 101 (not shown).

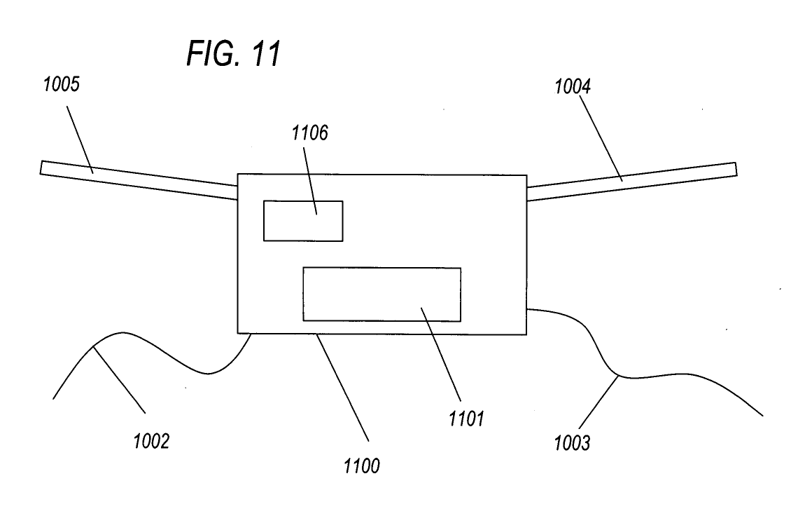

In a still further embodiment of the present invention, as illustrated in FIG. 11, the inverter 1106 and reed switch 1101 may be housed together in a unitary assembly 1100. Power may be input 1102 to the assembly 1100, and optionally output 1103 (e.g., in those embodiments of the present invention configured to provide power to external electronic devices). One or more illumination sources 1104, 1105 may be coupled directly to the assembly 1100 and in electronic communication with the components thereof. Although two illumination sources are shown by way of illustration in FIG. 11, it will be readily apparent to those of skill in the art and well within the scope of the present invention that any number of illumination sources, whether the same or different from one another, may be used in connection with alternate embodiments thereof.

Furthermore, the unitary assembly may be oriented at any of a number of locations in a fashion accessory to enable its operation. In some embodiments it may be advantageous to orient the assembly directly in, on, or beneath the frame or other rigid component of the fashion accessory that includes the illumination source(s). In alternate embodiments, the assembly may be oriented remotely from the frame or other rigid component of the fashion accessory and in electronic communication with the illumination source via wiring. Variations on this aspect of the present invention will be readily apparent to those of skill in the art and are considered to be well within the scope thereof.

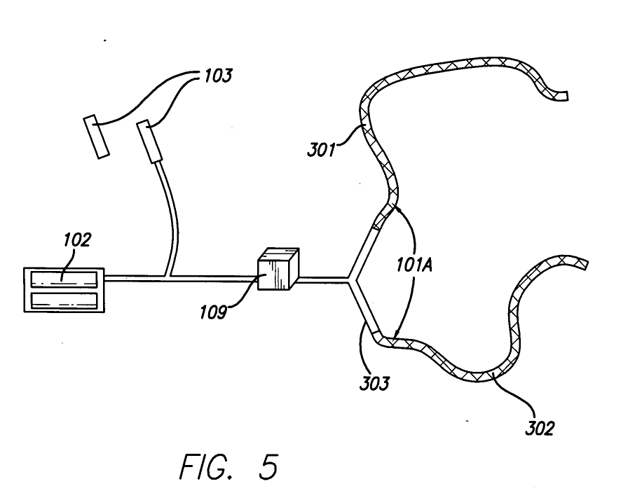

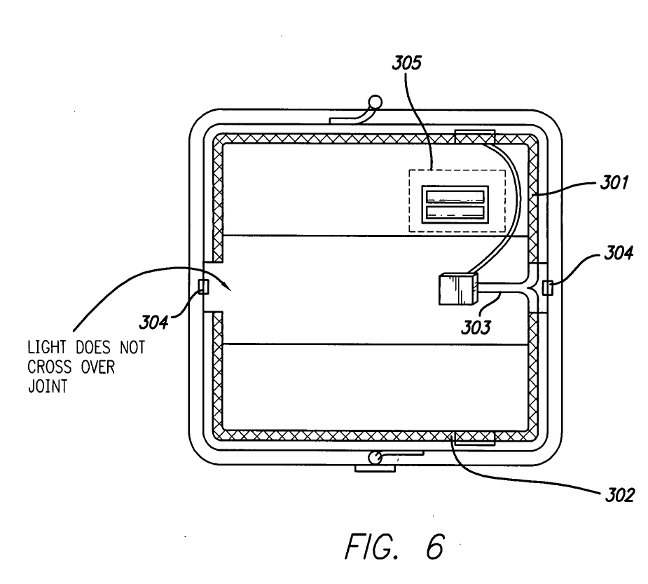

In an alternate embodiment of the present invention, as depicted in FIG. 5, the illumination source 101 may be a dual illumination source 101A; for example, two strands of electroluminescent wire 301, 302 in electronic communication with a bifurcated wire 303 that couples the strands of electroluminescent wire 301, 302 to a unitary power source 102. A magnetic switch 103 and inverter 109 may additionally be included in this embodiment of the present invention. As depicted in FIG. 6, particularly when the fashion accessory 100 is a purse, this configuration of the illumination device permits one to include each of the two strands of electroluminescent wire 301, 302 in the fashion accessory 100 on opposing sides of an opening in the fashion accessory 100. More particularly, each of the strands of electroluminescent wire 301, 302 may be included on a separate side of the fashion accessory opening such that no portion of either strand of electroluminescent wire 301, 302 is configured to transect the hinge 304 or other moveable element of the fashion accessory 100. Rather, the bifurcated wire 303 can be configured to transect the hinge 304. In this embodiment, the unitary power source 102 is illustrated as concealed in a pocket 305 to obscure it from view when the fashion accessory is opened. In various embodiments, the pocket 305 may include a zipper closure or the like to allow easy access to the unitary power source 102 (e.g., to change the batteries therein).

Electroluminescent wire is pliable, which allows it to be bent into a particular shape, e.g., for installation in the fashion accessory; however, electroluminescent wire tends not to stand up well to repeated bending, as the filaments therein may break. Thus, when electroluminescent wire transects the hinge of a purse or other fashion accessory, and the purse or other fashion accessory is repeatedly opened and closed (e.g., during the course of normal use), the wire may break or its function may become suboptimal. Therefore, in this particular embodiment of the present invention, the electroluminescent wire is not repeatedly bent; instead, it is only bent at the outset for installation. Thereafter, only the bifurcated wire is bent. This may markedly improve the durability of the fashion accessory and prolong the life expectancy of the illumination device.

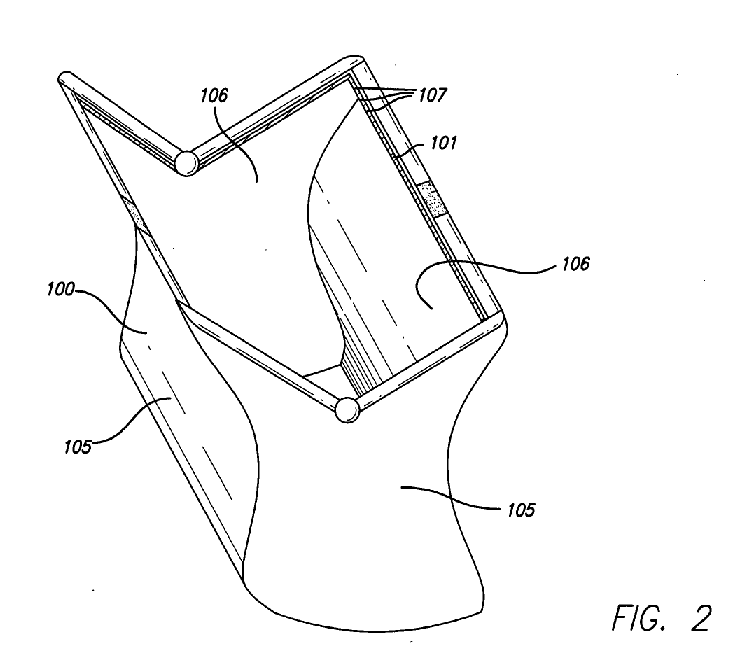

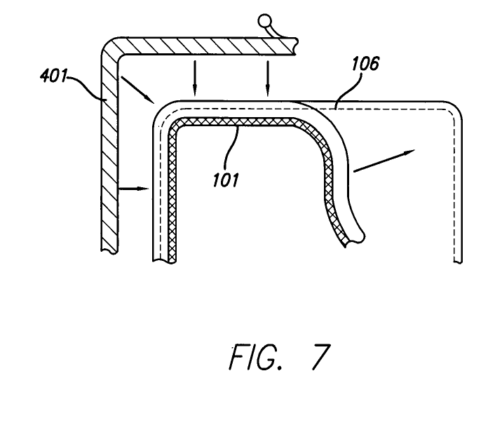

As depicted in FIG. 2, the power source 102, inverter 109, and wires 104 may be included inside the fashion accessory 100, but may be further configured between a wall 105 and an interior lining 106 of the fashion accessory 100. This configuration of the power source 102, inverter 109, and wires 104 may obscure these elements from view when the fashion accessory 100 is open. Moreover, the illumination source 101 may be stitched or otherwise affixed to the fashion accessory 100. In one embodiment of the present invention (i.e., the fashion accessory 100 being a purse), the illumination source 101 may be stitched or otherwise affixed to the fashion accessory 100 around the perimeter of the interior lining 106; preferably at or near the border between the interior lining 106 and the wall 105. Stitching 107 may be included to secure the illumination source 101 to the fashion accessory 100 in this manner. Alternatively or in addition, the illumination source 101 may be secured to the fashion accessory 100 by mechanical sealing (e.g., crimping) of the frame 401 of the fashion accessory about the lip of the illumination source 101, as depicted in FIG. 7.

Alternatively, it may be desirable to construct or manufacture the frame or other rigid component of the fashion accessory along with the illumination source, and, optionally, certain elements of the system electronics (e.g., the unitary assembly, etc.), before affixing these elements to the remaining components of the fashion accessory (e.g., those that may be constructed of various non-rigid materials, such as fabric, cloth, leather, etc.). Many alternate embodiments of the present invention in this regard may be readily implemented without undue experimentation, as will be readily appreciated by those of skill in the art; each is considered within the scope thereof.

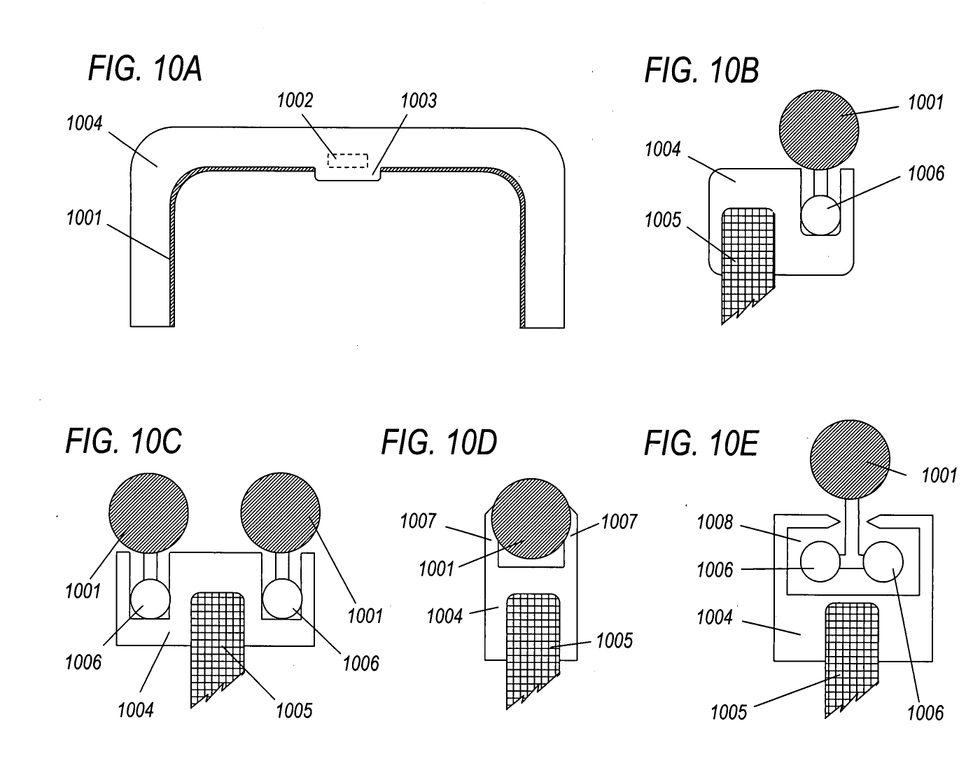

By way of non-limiting example, as depicted in FIG. 10, the illumination source 1001 may include a welt 1006 along its length. The welt 1006 provides a mechanical element that can be crimped or otherwise engaged by the frame 1004 or other rigid component of the fashion accessory, or by another element configured upon the frame (e.g., clips 1007, or a groove 1008). By way of example, FIG. 10A depicts a sidewall frame 1004 of a fashion accessory with a unitary assembly 1002 including a magnetic reed switch and an inverter. An extension 1003 in the frame 1004 ensures that the assembly 1002 is substantially hidden from view. An illumination source 1001 protrudes from the interior edge of the frame 1004.

As illustrated in FIG. 10B, frame 1004 may be configured to have an “S” shape in cross-section. In this embodiment, one side of the frame 1004 may be crimped along its length to mechanically engage and become affixed to a seam or other portion of the fashion accessory 1005. Similarly, the other side of the frame 1004 may be crimped along its length to mechanically engage and become affixed to the welt 1006 that runs along the axial length of the illumination source 1001.

As illustrated in FIG. 10C, in an alternate embodiment of the present invention, frame 1004 may be configured to have an “W” shape in cross-section. In this embodiment, both sides of the frame 1004 may be crimped along its length to mechanically engage and become affixed to each of two welts 1006 that run along the axial length and correspond to each of two illumination sources 1001. Similarly, the center portion of the frame 1004 may be crimped along its length to mechanically engage and become affixed to a seam or other portion of the fashion accessory 1005.

As illustrated in FIG. 10D, in another alternate embodiment of the present invention, frame 1004 may be configured to have an inverted “U” shape in cross-section. In this embodiment, the frame 1004 may be crimped along its length to mechanically engage and become affixed to a seam or other portion of the fashion accessory 1005. The external portion of the frame 1004 may include a series of clips 1007 spaced along its length to mechanically engage an illumination source 1001. In this particular embodiment of the present invention, it may not be desirable for the illumination source 1001 to include a welt.

As illustrated in FIG. 10E, in another alternate embodiment of the present invention, frame 1004 may be configured such it may be crimped along its length on one side to mechanically engage and become affixed to a seam or other portion of the fashion accessory 1005. The other side of the frame 1004 may include a groove 1008 along its length to mechanically engage a double welt 1009 that runs along the axial length of the illumination source 1001. In this embodiment, the groove 1008 may engage the double welt 1009 by sliding the illumination source 1001 and double welt 1009 into the groove 1008 from an axial end thereof.

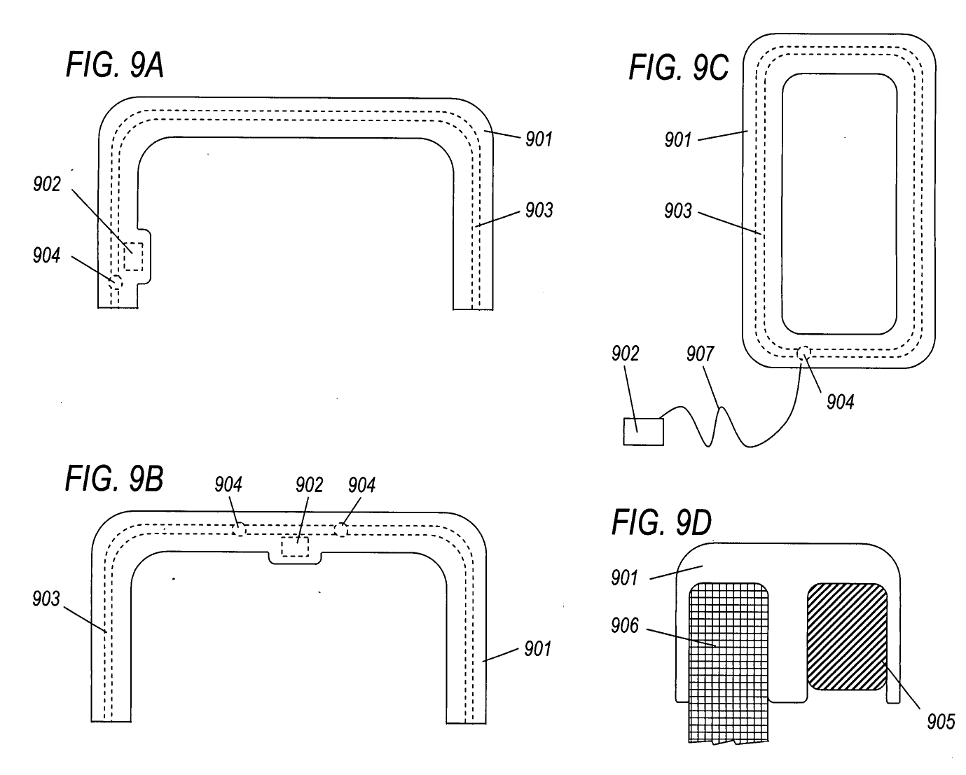

In an alternate embodiment, the illumination source may be one or more lights, such as LEDs, in optical communication with a light-transmitting material (e.g., various plastics, glass, etc.) configured in the frame or other rigid component of a fashion accessory. For instance, with reference to FIG. 9, a groove 903 may be formed through a frame 901 of a fashion accessory that is filled with a light-transmitting material 905. In operation, when the one or more lights 904 (e.g., LEDs) are illuminated (based on, for example, operation of a reed switch and inverter assembly 902), the light given off is transmitted through the light-transmitting material 905, such that a glowing effect along the entirety of the light-transmitting material 905 is created; thereby illuminating the interior of the fashion accessory. As depicted in FIG. 9D, the frame 901 or other rigid component of the fashion accessory may be crimped or otherwise attached to a seam or other portion of the fashion accessory 906.

As further described herein, the reed switch and inverter assembly 902 can be oriented in any number of locations in the fashion accessory, as will be readily appreciated by those of skill in the art. By way of example, the assembly 902 may be oriented at one end of a sidewall frame for a fashion accessory (FIG. 9A), in the center of a sidewall frame for a fashion accessory (FIG. 9B), or in a location remote from the frame and in electronic communication with the one or more lights 904 via wiring 907. The latter variation may be particularly desirable when the frame and lighting for the interior of a fashion accessory are not mechanically proximate to a location where operation of a magnetic reed switch would be effective. For example, if the frame and lighting for the interior of a purse are configured to be in the bottom of the purse while the reed switch is desired to be located near the opening of the purse, then this type of mechanical arrangement may be particularly effective. Those of skill in the art will readily recognize a number of alternate configurations in connection with both purses and alternate fashion accessories; each of these is considered to be well within the scope of the present invention and can be readily implemented without undue experimentation.

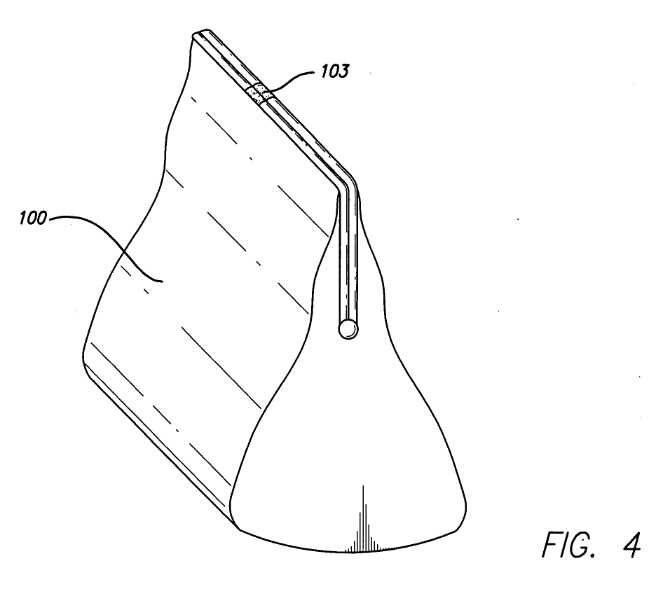

The switch 103 of the present invention may be included at or near an opening 108 of the fashion accessory 100. As illustratively depicted in FIG. 1, the switch 103 is included at the opening 108 of a fashion accessory 100. When the fashion accessory 100 is open, the switch 103 causes the illumination source 101 to illuminate, and when the fashion accessory 100 is closed, the switch 103 causes the illumination source 101 to turn off. Depending on the overall configuration of the fashion accessory 100 and the remaining elements of the embodiment of the present invention that is included therewith, the switch 103 may be substantially obscured from view. However, in the embodiment illustratively depicted in FIG. 4, an individual may observe the switch 103. Therefore, in certain embodiments of the present invention, and particularly those embodiments wherein the switch 103 is configured to be visible when the fashion accessory 100 is in the open position, it may be desirable to select a relatively small switch 103.

While the description above refers to particular embodiments of the present invention, it will be understood that many modifications may be made without departing from the spirit thereof. The accompanying claims are intended to cover such modifications as would fall within the true scope and spirit of the present invention. The presently disclosed embodiments are therefore to be considered in all respects as illustrative and not restrictive, the scope of the invention being indicated by the appended claims, rather than the foregoing description, and all changes that come within the meaning and range of equivalency of the claims are therefore intended to be embraced therein.

1. A fashion accessory with an illumination apparatus to illuminate the interior thereof, comprising:
a substantially rigid frame;
an illumination source mounted directly to the frame;
a power source in electronic communication with the illumination source; and
a switch in electronic communication with the illumination source.

2. The fashion accessory of claim 1, wherein the illumination source comprises an electric luminescent wire.

3. The fashion accessory of claim 2, wherein the electric luminescent wire further comprises a welt along at least a portion of its length, and the electric luminescent wire is affixed to the frame by a mechanical interaction between the frame and the welt.

4. The fashion accessory of claim 3, wherein the welt is a double welt.

5. The fashion accessory of claim 2, wherein the frame further comprises at least one set of clips, and the electric luminescent wire is affixed to the frame by a mechanical interaction with the clips.

6. The fashion accessory of claim 1, wherein the frame further comprises a light-transmitting material in optical communication with the illumination source.

7. The fashion accessory of claim 1, wherein the illumination source is at least one light emitting diode (“LED”).

8. The fashion accessory of claim 1, wherein the illumination source is activated when the switch is in an “on” position and the illumination source is deactivated when the switch is in an “off” position, and the switch is in the “on” position when the fashion accessory is open, and the switch is in the “off” position when the fashion accessory is closed.

9. The fashion accessory of claim 8, wherein when the illumination source is activated, it glows with a color.

10. The fashion accessory of claim 1, wherein the switch is a magnetic reed switch.

11. The fashion accessory of claim 1, further including an inverter configured between the power source and the illumination source, and electrically coupled thereto.

12. The fashion accessory of claim 11, wherein the inverter and the switch are housed together in a unitary assembly.

13. The fashion accessory of claim 1, selected from the group consisting of a purse, a handbag, a pocketbook, a wallet, a backpack, a briefcase, a satchel, an article of luggage, a suitcase, a case for sunglasses, and a case for makeup.

14. The fashion accessory of claim 1, wherein the power source is a rechargeable power source.

15. The fashion accessory of claim 1, further comprising an internal fashion accessory power outlet.

16. A method for assembling a fashion accessory with an illumination device, comprising:
providing a substantially rigid frame to which an illumination source is directly mounted, the illumination source in electronic communication with a switch and a power source; and
mechanically affixing the substantially rigid frame to a relatively less rigid component of the fashion accessory.

17. The method of claim 16, wherein the illumination source is selected from the group consisting of at least one electric luminescent wire and at least one light emitting diode (“LED”).

18. The method of claim 16, wherein the switch is configured such that the illumination source is activated when the switch is in an “on” position and the illumination source is deactivated when the switch is in an “off” position, and the switch is in the “on” position when the fashion accessory is open, and the switch is in the “off” position when the fashion accessory is closed.

19. The method of claim 16, further comprising electrically coupling an inverter between the power source and the illumination source.

20. The method of claim 19, wherein the inverter and the switch are housed together in a unitary assembly.

21. The method of claim 16, wherein the fashion accessory is selected from the group consisting of a purse, a handbag, a pocketbook, a wallet, a backpack, a briefcase, a satchel, an article of luggage, a suitcase, a case for sunglasses, and a case for makeup.
